(19) United States
(12) Patent Application Publication
(10) Pub. No.: US 2007/0255753 A1
(43) Pub. Date: Nov. 1, 2007

(54) METHOD, SYSTEM, AND COMPUTER PROGRAM PRODUCT FOR PROVIDING USER-DEPENDENT REPUTATION SERVICES

(75) Inventor: Ori Pomerantz, Austin, TX (US)

Correspondence Address: CANTOR COLBURN LLP - IBM AUSTIN, 55 GRIFFIN ROAD SOUTH, BLOOMFIELD, CT, 06002, US

(73) Assignee: International Business Machines Corporation, Armonk, NY (US)

(21) Appl. No.: 11/380,964

(22) Filed: May 1, 2006

(51) Int. Cl. G06F 7/00

(52) U.S. Cl. 707/104.1

(57) ABSTRACT

A method, system, and computer program product for providing user-dependent reputation services is provided. The method includes receiving a rating for a content submission from a viewer of the content submission. The rating specifies a value attributed to the content submission. The method also includes assigning a viewer identifier to the viewer and mapping the viewer identifier to a content identifier of the content submission. The content submission is classified by content type. The method further includes storing the viewer identifier and content identifier in a database table that is searchable by at least one of the content type and viewer identifier. The method further includes presenting content to requesting viewers based upon at least one of the content type and viewer identifier selected by the requesting viewers via a search query.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to online content rating systems and, more particularly to a method, system, and computer program product for providing user-dependent reputation services.

2. Description of Background

Before our invention, websites providing content rating systems typically assign a value to content submissions based upon peer inputs. For example, web logs (BLOGs) enable members of a BLOGing community to comment on the overall value or interest of a fellow BLOGer's submission. In www.myspace.com™, for example, a registered user submits a BLOG entry on the user's individual web page that is available to the community of users upon accessing the user's web page. Each of the community members may directly respond to the author of the BLOG entry with a comment, which is discernible by the author at his/her web page. Alternatively, a reader of the entry may re-post the BLOG entry on their own individual web page, which is then available to friends and viewers of the re-posting member via the re-posting member's individual page.

Other applications, such as on-line auction services (e.g., www.e-Bay.com™), information exchange services (e.g., www.slashdot.org™), etc., utilize rating systems. These rating systems generally provide a single reputation value or score that reflects a collective view of the content submission.

What is generally not available to the community of users is information about the users who supply the ratings. The value of one user's opinion of a content submission may be more valuable to certain community members than the value of another user's opinion. For example, one rating member may be an expert in a particular field or subject, while another rating member may be knowledgeable but less experienced than the first rating member. Thus, the identity of the rating member with respect to a content submission may be of great importance to the content viewing audience in assessing the value of the content, and/or the integrity or reputation of the content submitter.

What is needed, therefore, is a rating system that offers information relating to users that rate content submissions, in addition to the rating of the content, whereby the information is linked to the content and the submitter of the content.

### SUMMARY OF THE INVENTION

The shortcomings of the prior art are overcome and additional advantages are provided through the provision of a method, system, and computer program product for providing user-dependent reputation services. The method includes receiving a rating for a content submission from a viewer of the content submission. The rating specifies a value attributed to the content submission. The method also includes assigning a viewer identifier to the viewer and mapping the viewer identifier to a content identifier of the content submission. The content submission is classified by content type. The method farther includes storing the viewer identifier and content identifier in a database table that is searchable by at least one of the content type and viewer identifier. The method further includes presenting content to requesting viewers based upon at least one of the content type and viewer identifier selected by the requesting viewers via a search query.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

Technical Effects

As a result of the summarized invention, technically we have achieved a solution which provides user-dependent ratings of content submissions that supply information about the users rating the content submissions along with the ratings so that the content viewing audience can better assess the value of the content submission.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram of a system upon which the rating services may be implemented in exemplary embodiments;

FIG. 2 illustrates one example of a flow diagram describing a process for implementing the rating services in exemplary embodiments; and

FIG. 3 illustrates one example of web page including user-supplied ratings and rater information implemented via the rating services in exemplary embodiments.

The detailed description explains the preferred embodiments of the invention, together with advantages and features, by way of example with reference to the drawings.

### DETAILED DESCRIPTION OF THE INVENTION

In accordance with exemplary embodiments, rating services are provided for enabling members of an online community to obtain detailed information about a content viewer that has rated content submissions in order to assess the value or trustworthiness of the rating applied to the content submissions. The content submissions may be searchable by rating members and content types associated with the submissions.

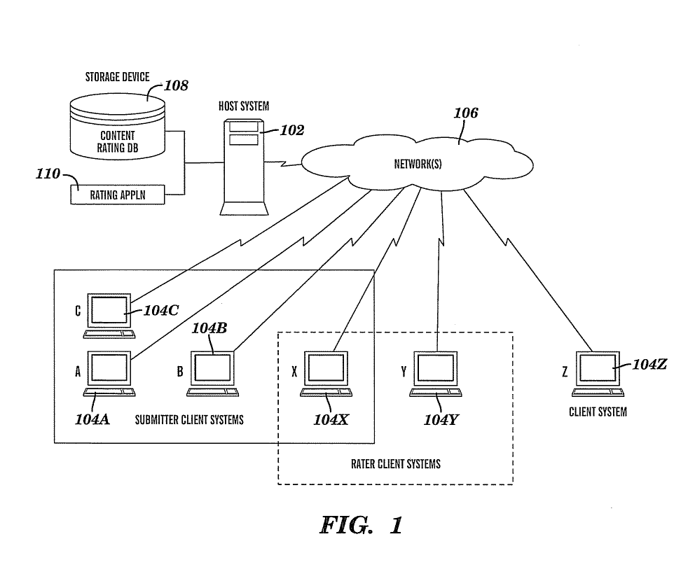

Tuning now to the drawings in greater detail, it will be seen that in FIG. 1, a system upon which the rating services may be implemented in exemplary embodiments will now be described. The system of FIG. 1 includes a host system 102 in communication with client systems 104 over a network 106. Host system 102 may be a high speed processing device (e.g., a mainframe computer) that handles large volumes of processing requests from client systems 104. In exemplary embodiments, host system 102 functions as an applications server, web server, and database management server.

For purposes of illustration, host system 102 is an information exchange server that receives content submissions from client systems (e.g., documents authored by individuals and submitted via the client systems), stores the submissions, and provides access to the content along with viewer-supplied ratings. However, it will be understood that the rating services described herein may be implemented via any type of service that utilizes a content rating system (e.g., web-based auction service, web log service, etc.).

While only a single host system 102 is shown in the system 100 of FIG. 1, it will be understood that multiple host systems may be implemented, each in communication with one another via direct coupling or via one or more networks. For example, multiple host systems may be interconnected through a distributed network architecture.

Client systems 104 may comprise desktop or general-purpose computer devices that generate data and processing requests, such as requests to utilize applications and perform searches. For example, client systems 104 may request web pages, documents, and files that are stored in various storage systems (e.g., storage device 108). Access to the information provided by host system 102 may be implemented via registration processes that identify users of each of client systems 104.

Client systems 104A-104C and 104X refer to those that submit content to the host system 102. Client systems 104X and 104Y refer to those that rate the content submitted by client systems 104A-104C and X. Client system 104Z refers to a user system that does not submit or rate content but searches and views content submitted by client systems 104A-104C and 104X and rated by client systems 104X and 104Y. Note that client system 104X is both a content submitter and a rater, however, client system 104X is precluded from rating its own content.

Network 106 may be any type of communications network known in the art. For example, network 106 may be an intranet, extranet, or an internetwork, such as the Internet, or a combination thereof. Network 106 may be a wireless or wireline network.

Host system 102 is also in communication with storage device 108. Storage device 108 stores content submissions received from client systems 104A-104C. Storage device 108 also stores one or more rating database tables generated and maintained by the rating services described herein. The database tables include searchable fields of information that enable users to retrieve content submissions by content type and/or a particular rater of the content.

In exemplary embodiments, host system 102 executes applications, e.g., business applications, a web server, content manager, etc., as dictated by the needs of the enterprise of the host system 102. The host system 102 also executes one or more applications for implementing the rating services described herein. These one or more applications are collectively referred to as rating application 110. The rating application 110 builds rating database tables including searchable fields as described herein.

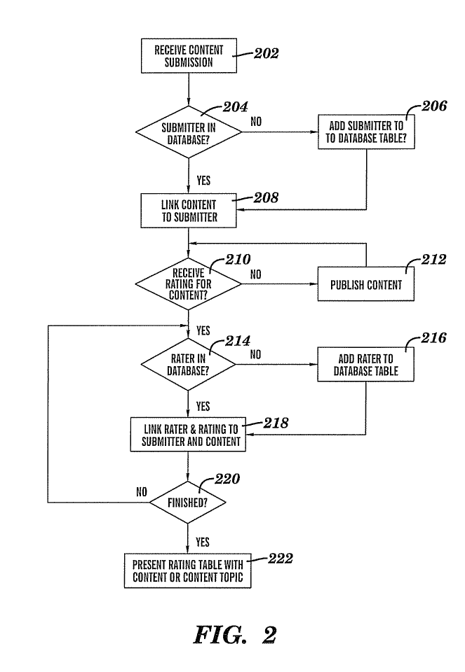

Turing now to FIG. 2, a process for implementing the rating services will now be described in exemplary embodiments. At step 202, the rating application 110 receives a content submission from one of client systems 104 (e.g., submitter A, B, C, or X). As host system 102 implements an information exchange server, the content submission may be an article written by the submitter. However, it will be understood that the content submission may be details of a product offering, service offering, journal entry, or other type of content, depending upon the services provided by the host system 102. The content may be classified by content type or subject matter. For example, an article submitted by a client system about the Civil War may be stored in a content category or type, such as ‘U.S. Military History’. The rating application 110 identifies the submitter of the content via, e.g., an account identifier used in registering users of an application, Internet Protocol (IP) address of the user, user name, or other means of identification.

The rating application 110 checks the rating database table in storage device 108 to see if the submitter of the content is recorded therein at step 204. If not, the rating application 110 adds the submitter's identification in the rating database table at step 206. The content is linked to the submitter in the database table at step 208 via, e.g., a content identifier (content title, unique value, or other descriptor). The content is stored in storage device 108.

At step 210, it is determined whether a rating has been received from one of client systems 104 (e.g., client systems 104X or 104Y). If not, the content is published or made available to the user community (e.g., client systems 104A-104C, 104X, 104Y, and 104Z) at step 212. The process returns to step 210, as ratings may continue to be submitted for the content over time. If, however, there is a rating for the content, the rating application 110 identifies the rater and checks to see if the rater's identification is stored in the rating database table at step 214. If not, the rating application 110 creates an identifier for the rater and stores it in the rating database table at step 216.

The rater identification and corresponding rating are linked to the submitter identification and the content submission via the content identifier at step 218. The rating reflects not only the quality of the content submission from the viewpoint of the rater, but may also reflect the reputation of the content submitter from the viewpoint of the rater.

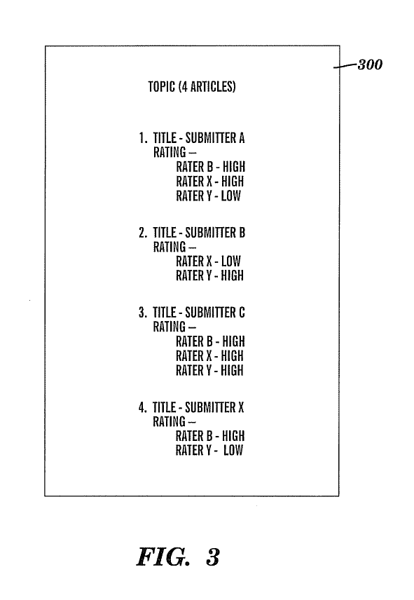

At step 220, it is determined whether a new rating has been received for the content submission. If so, the process returns to step 214. Otherwise, the rating database table with assigned values is available for searching by the viewing audience. A requesting viewer may search for content by content type and/or viewer identification. The database table provides fields of information that include the content type and viewer identification. The requested content is presented to requester. A sample web page with ratings and rater information is shown and described in FIG. 3. If desired, a rater may access the content at a future time and modify the rating. The database table stores the information acquired via the process described in FIG. 2 so that a user (e.g., client system 104Z) may receive content that is presented in a prioritized fashion based upon the value attributed to the raters that have assigned ratings to the content. For example, if the user of client system 104Z values the opinion of a particular rating, e.g., rater X of client system 104X, the articles shown in FIG. 3 may be presented in an order that provides the articles submitted by rater X and the articles rated highly by submitter X at the top of the list. Thus, the articles may be presented to client system 104Z in the following order:

Article 4

Article 1

Article 3

Article 2

Another user may receive the articles in a different order depending upon the value attributed to the raters.

In alternative exemplary embodiments, the rating application 110 may acquire background information relating to the rater (e.g., client systems 104X, 104Y) via, e.g., a prompt to the rater requesting information. For example, the rater may be asked about their technical background or area of expertise including the amount of time spent learning or working in a particular field. Alternatively, the rating application 110 may automatically assign a knowledge value to the rater based upon the relevance and/or value of content previously submitted by the rater, which reflects a particular level of understanding of the subject matter. The background information may be accessed by a content viewer, e.g., by clicking on the viewer identifier presented along with the content and rating.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for providing user-dependent reputation services, comprising:
receiving a rating for a content submission from a viewer of the content submission, the rating specifying a value attributed to the content submission;
assigning a viewer identifier to the viewer and mapping the viewer identifier to a content identifier of the content submission, the content submission classified by content type;
storing the viewer identifier and content identifier in a database table that is searchable by at least one of the content type and viewer identifier; and
presenting content to requesting viewers based upon at least one of the content type and viewer identifier selected by the requesting viewers via a search query.

2. The method of claim 1, further comprising:
applying background information of the viewer to the viewer identifier, the background information reflecting a level of knowledge the viewer possesses with respect to a topic or skill; wherein the presenting content includes presenting the background information to the requesting viewers.

3. The method of claim 1, further comprising:
modifying the rating in response to a request from the viewer.

4. The method of claim 1, wherein the rating further specifies a reputation attributed to a submitter of the content submission by the viewer.

5. The method of claim 1, wherein the content submission is at least one of:
information detailing a product sold by the submitter;
information detailing a service offered by the submitter;
an article written by the submitter; and
a journal entry written by the submitter.

6. A system for providing user-dependent reputation services, comprising:
a computer processing device;
a database table stored in the computer processing device; and
a rating application executing on the computer processing device, the rating application performing:
receiving a rating for a content submission from a viewer of the content submission, the rating specifying a value attributed to the content submission;
assigning a viewer identifier to the viewer and mapping the viewer identifier to a content identifier of the content submission, the content submission classified by content type;
storing the viewer identifier and content identifier in the database table that is searchable by at least one of the content type and viewer identifier; and
presenting content to requesting viewers based upon at least one of the content type and viewer identifier selected by the requesting viewers via a search query.

7. The system of claim 6, wherein the rating application further performs:
applying background information of the viewer to the viewer identifier, the background information reflecting a level of knowledge the viewer possesses with respect to a topic or skill; wherein the presenting content includes presenting the background information to the requesting viewers.

8. The system of claim 6, wherein the rating application further performs:
modifying the rating in response to a request from the viewer.

9. The system of claim 6, wherein the rating further specifies a reputation attributed to a submitter of the content submission by the viewer.

10. The system of claim 6, wherein the content submission is at least one of:
information detailing a product sold by the submitter;
information detailing a service offered by the submitter;
an article written by the submitter; and
a journal entry written by the submitter.

11. A computer program product for implementing user-dependent reputation services, the computer program product including instructions for implementing a method, comprising:
receiving a rating for a content submission from a viewer of the content submission, the rating specifying a value attributed to the content submission;
assigning a viewer identifier to the viewer and mapping the viewer identifier to a content identifier of the content submission, the content submission classified by content type;
storing the viewer identifier and content identifier in a database table that is searchable by at least one of the content type and viewer identifier; and
presenting content to requesting viewers based upon at least one of the content type and viewer identifier selected by the requesting viewers via a search query.

12. The computer program product of claim 11, further comprising instructions for implementing:
applying background information of the viewer to the viewer identifier, the background information reflecting a level of knowledge the viewer possesses with respect to a topic or skill; wherein the presenting content includes presenting the background information to the requesting viewers.

13. The computer program product of claim 11, further comprising instructions for implementing:
modifying the rating in response to a request from the viewer.

14. The computer program product of claim 11, wherein the rating further specifies a reputation attributed to a submitter of the content submission by the viewer.

15. The method of claim 11, wherein the content submission is at least one of:
information detailing a product sold by the submitter;
information detailing a service offered by the submitter;
an article written by the submitter; and
a journal entry written by the submitter.
